(19) United States
(12) Patent Application Publication
(10) Pub. No.: US 2022/0063939 A1
(43) Pub. Date: Mar. 3, 2022

(54) IMAGE PROCESSING APPARATUS AND PAPER FEED METHOD

(71) Applicant: TOSHIBA TEC KABUSHIKI KAISHA, Tokyo (JP)

(72) Inventor: Toshiaki Oshiro, Izu Shizuoka (JP)

(21) Appl. No.: 17/010,860

(22) Filed: Sep. 3, 2020

(51) Int. Cl. B65H 3/06; G03G 15/00

(52) U.S. Cl. CPC B65H 3/0607; G03G 15/6529; B65H 3/0669; B65H 3/0676

(57) ABSTRACT

According to one embodiment, there is provided an image processing apparatus including a sheet storage unit, a pickup roller, a paper feed roller, a separation roller, a roller drive unit, a roller pressing unit, and a drive control unit. The pickup roller picks up a sheet from the sheet storage unit. The paper feed roller conveys the sheet picked up by the pickup roller. The separation roller is disposed to face the paper feed roller. The roller drive unit drives the separation roller. The roller pressing unit presses the separation roller against the paper feed roller. The drive control unit controls the roller drive unit so as to generate a conveying force for conveying the sheet and a returning force for pushing the sheet back in a direction opposite to a conveyance direction.

### FIELD

Embodiments described herein relate generally to an image processing apparatus and a paper feed method.

### BACKGROUND

Conventionally, in an image processing apparatus, a paper feed device that sequentially conveys a plurality of stacked sheets toward a conveyance path is used. The paper feed device includes a sheet separation mechanism for preventing double feeding of sheets. There is a sheet separation mechanism including a separation roller driven to reversely rotate by a power of a motor and a reverse-rotation separation mechanism using a torque limiter. However, since the sheet separation mechanism described above requires two components, a reverse rotation driving motor and a separating torque limiter, there is a possibility that an arrangement space thereof becomes large or the apparatus becomes large.

### DESCRIPTION OF THE DRAWINGS

FIG. 1 is a front view illustrating an overall configuration of an image processing apparatus of a first embodiment;

FIG. 2 is a schematic diagram illustrating a configuration of a paper feed device of the first embodiment;

FIG. 3 is a diagram for illustrating a limiting torque of a motor of the first embodiment;

FIG. 4 is a diagram when one sheet is conveyed to a nip of the paper feed device of the first embodiment;

FIG. 5 is a diagram when two sheets are conveyed to the nip of the paper feed device of the first embodiment; and

FIG. 6 is a side view illustrating a paper feed device of a second embodiment.

### DETAILED DESCRIPTION

In general, according to one embodiment, there is provided an image processing apparatus including a sheet storage unit, a pickup roller, a paper feed roller, a separation roller, a roller drive unit, a roller pressing unit, and a drive control unit. The pickup roller picks up a sheet from the sheet storage unit. The paper feed roller conveys the sheet picked up by the pickup roller. The separation roller is disposed to face the paper feed roller. The roller drive unit drives the separation roller. The roller pressing unit presses the separation roller against the paper feed roller. The drive control unit controls the roller drive unit so as to generate a conveying force for conveying the sheet and a returning force for pushing the sheet back in a direction opposite to a conveyance direction.

Hereinafter, an image processing apparatus according to an embodiment will be described with reference to the accompanying drawings. In each figure, the same configurations are designated by the same reference numerals.

### First Embodiment

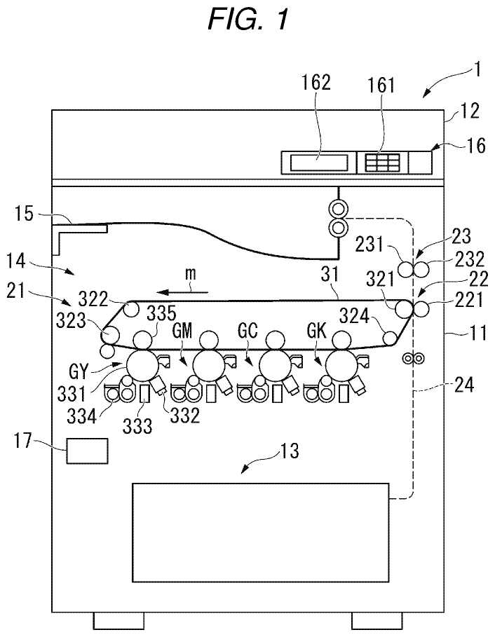

FIG. 1 is a front view illustrating an overall configuration of the image processing apparatus of the embodiment. For example, an image processing apparatus 1 is a multi-function peripheral (MFP). However, the image processing apparatus 1 is not limited to the example described above, and may be a copying machine or a printer.

As illustrated in FIG. 1, the image processing apparatus 1 includes a casing 11, a scanner unit 12, a paper feed device 13, a printer unit 14, a paper discharge unit 15, and a control panel (information input unit) 16.

The casing 11 forms an outer shell of the image processing apparatus 1. The casing 11 stores the scanner unit 12, the paper feed device 13, and the printer unit 14.

The scanner unit 12 reads an image to be read based on brightness and darkness of light. The scanner unit 12 generates and records image information indicating the read image. The scanner unit 12 outputs the generated image information to the printer unit 14. The recorded image information may be transmitted to an external device or the like via a network.

The paper feed device 13 supplies a sheet S, which is a sheet-shaped recording medium, such as a paper sheet, to a conveyance path 24 one by one at the timing when the printer unit 14 forms a toner image.

The printer unit 14 forms the toner image, which is an output image, on the sheet S with a recording material such as a toner based on image information acquired from the scanner unit 12 or an external device.

In the embodiment, for convenience of description, an intermediate transfer type printer unit 14 is taken as an example for description. However, the configuration of the embodiment is also applicable to an image processing apparatus including a direct transfer type image forming unit. The printer unit 14 includes an intermediate transfer unit 21, a secondary transfer unit 22, a fixing device 23, and the conveyance path 24.

The intermediate transfer unit 21 includes an intermediate transfer belt 31, a plurality of rollers 321, 322, 323, and 324, and a plurality of image forming units GY, GM, GC, and GK.

The intermediate transfer belt 31 is formed in an endless shape. The plurality of rollers 321, 322, 323, and 324 support the intermediate transfer belt 31. With this configuration, the intermediate transfer belt 31 can run endlessly in a direction indicated by an arrow m in FIG. 1.

The plurality of image forming units GY, GM, GC, and GK include a yellow image forming unit GY, a magenta image forming unit GM, a cyan image forming unit GC, and a black image forming unit GK. Each of the image forming units GY, GM, GC, and GK includes a photoreceptor drum 331, a charger 332, an exposure unit 333, a developing device 334, and a transfer roller 335. Each of the image forming units GY, GM, GC, and GK transfers the toner image formed on the surface of the photoconductor drum 331 to the intermediate transfer belt 31.

The secondary transfer unit 22 includes a transfer roller 221. The transfer roller 221 contacts the outer surface of the intermediate transfer belt 31. One belt roller 321 that supports the intermediate transfer belt 31 is included in the components of the secondary transfer unit 22. The sheet S is pinched between the transfer roller 221 and the belt roller 321 together with the intermediate transfer belt 31. With this configuration, the toner image on the intermediate transfer belt 31 is transferred to the sheet S.

The fixing device 23 includes a heat roller 231 and a press roller 232. The fixing device 23 heats and pressurizes the sheet S passing between the heat roller 231 and the press roller 232. With this configuration, the toner image transferred to the sheet S is fixed on the sheet S.

The conveyance path 24 extends from the paper feed device 13 to the paper discharge unit 15 through the secondary transfer unit 22 and the fixing device 23. While the sheet S is conveyed on the conveyance path 24, the sheet S moves from the paper feed device 13 to the paper discharge unit 15 through the secondary transfer unit 22 and the fixing device 23. The paper discharge unit 15 discharges the sheet S on which the image is formed by the printer unit 14.

The control panel 16 includes a panel 161 and a display 162. The panel 161 receives input of various operation instructions. The display 162 is an image display device such as a liquid crystal display (LCD) or an organic electro luminescence (EL) display. The display 162 displays various types of information regarding the image processing apparatus 1. The display 162 displays, for example, an operation mode of the image processing apparatus 1 selected by a user.

The image processing apparatus 1 designates the operation mode by, for example, performing an operation input by pressing an input button or the like provided on the panel 161. Alternatively, the user may designate the operation mode of the image processing apparatus 1 by, for example, performing an operation input by tapping an icon or the like displayed on a touch panel in which the display 162 and the panel 161 are integrally configured.

Hereinafter, a configuration of the paper feed device 13 of the embodiment will be described in detail.

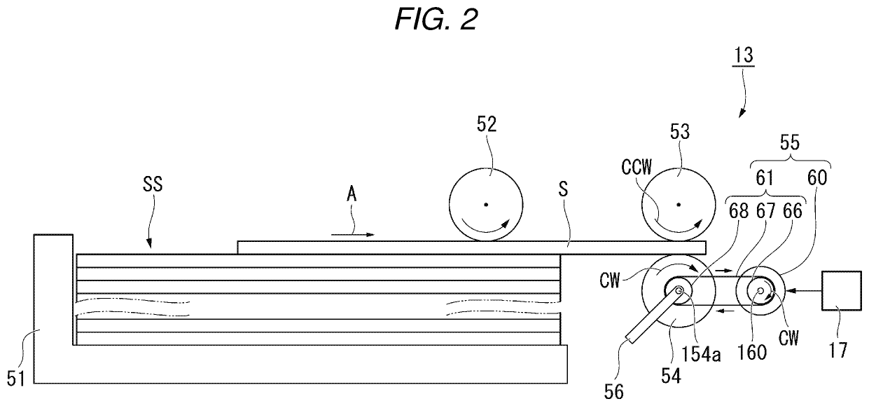

FIG. 2 is a schematic diagram illustrating the configuration of the paper feed device 13.

As illustrated in FIG. 2, the paper feed device 13 of the embodiment includes a sheet feed cassette (sheet storage unit) 51, a pickup roller 52, a paper feed roller 53, a separation roller 54, a roller drive unit 55, and a roller pressing unit 56. In this embodiment, the drive control unit that controls the drive of the paper feed device 13 is configured by a part of a control unit 17. The drive control unit may be a control device dedicated to the paper feed device different from the control unit 17.

The sheet feed cassette 51 is attached to the casing 11 illustrated in FIG. 1 so as to be pulled out. The sheet feed cassette 51 stores a sheet bundle SS including a plurality of sheets S. A lifter (not illustrated) is provided on the bottom surface of the sheet feed cassette 51. The lifter rises in accordance with the consumption of the sheet bundle SS stored in the sheet feed cassette 51, thereby maintaining the upper portion of the sheet bundle SS at a substantially constant height.

The pickup roller 52 is provided above the sheet feed cassette 51. The material of the pickup roller 52 is an elastic member having a frictional force such as rubber. The pickup roller 52 picks up the uppermost sheet S of the sheet bundle SS stored in the sheet feed cassette 51 and sends the uppermost sheet S toward the paper feed roller 53. The pickup roller 52 is retracted upward by a pickup roller drive unit (not illustrated) when the sheet feed cassette 51 is pulled out from the casing 11 illustrated in FIG. 1. The pickup roller 52 is moved to a position where the pickup roller 52 comes into contact with the upper surface of the sheet bundle SS by the pickup roller drive unit when the sheet feed cassette 51 is stored in the casing 11.

The paper feed roller 53 and the separation roller 54 are provided on the downstream side of the sheet feed cassette 51 in the sheet conveyance direction. The material of the paper feed roller 53 and the separation roller 54 is an elastic member having a frictional force such as rubber. The paper feed roller 53 sends the sheet S picked up by the pickup roller 52 to the conveyance path 24. The paper feed roller 53 abuts on the upper surface of the sheet S. The paper feed roller 53 is driven by a drive source (not illustrated) such as a motor.

The separation roller 54 is disposed to face the paper feed roller 53. The separation roller 54 is pressed against the paper feed roller 53 by the roller pressing unit 56. The separation roller 54 and the paper feed roller 53 abut on each other. The separation roller 54 abuts on the lower surface of the sheet S conveyed between the separation roller 54 and the paper feed roller 53.

The roller drive unit 55 drives the separation roller 54. The roller drive unit 55 of the embodiment includes a motor 60 and a transmission unit 61. The motor 60 of the embodiment is a DC motor whose torque can be controlled by the current. The transmission unit 61 transmits the driving force of the motor 60 to the separation roller 54. The transmission unit 61 of the embodiment includes a first pulley 66, a second pulley 67, and a belt 68. The first pulley 66 is attached to a rotation shaft 160 of the motor 60. The second pulley 67 is attached to a rotation shaft 154 of the separation roller 54. The belt 68 is endlessly stretched between the first pulley 66 and the second pulley 67. The control unit 17 controls driving of the roller drive unit 55.

The paper feed device 13 rotates the paper feed roller 53 in a counterclockwise direction CCW when the sheet S picked up by the pickup roller 52 is conveyed. When the paper feed roller 53 is driven, the control unit 17 rotates the motor 60 in a direction in which the separation roller 54 is rotated in the same counterclockwise direction CCW as the paper feed roller 53.

As described above, the motor 60 of the embodiment is configured by a DC motor. Generally, a DC motor has characteristics that generated torque increases as a current value increases. In the paper feed device 13 of the embodiment, torque generated by the motor 60 is made variable by controlling the current value to be supplied to the motor 60 by utilizing the characteristics described above of the DC motor (motor 60). It can be said that the torque generated by the motor 60 is limited by the current value. Hereinafter, the torque generated by the motor that is limited according to the current value is referred to as “limiting torque” of the motor 60.

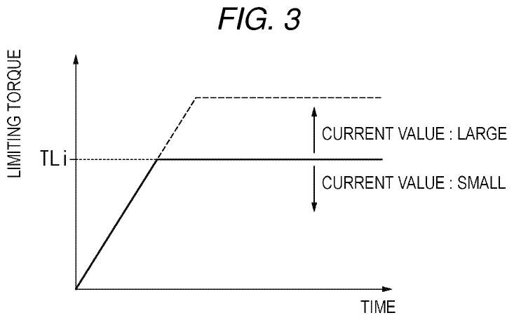

FIG. 3 is a diagram for illustrating the limiting torque of the motor 60. In FIG. 3, the horizontal axis represents time and the vertical axis represents load torque applied to the motor 60.

As illustrated in FIG. 3, limiting torque TLi of the motor 60 increases and becomes constant over time. The limiting torque TLi of the motor 60 is variable according to a value of a supplied current. The limiting torque TLi of the motor 60 increases as a supply current to the motor 60 increases, and decreases as the supply current to the motor 60 decreases.

The motor 60 continues to rotate in a predetermined direction when a load smaller than the limiting torque TLi (prescribed torque) is applied. On the other hand, the motor 60 rotates in a direction opposite to the predetermined direction when a load larger than the limiting torque TLi (prescribed torque) is applied. In the paper feed device 13, the control unit 17 sets the limiting torque TLi of the motor 60 to a predetermined value by controlling the current to be supplied to the motor 60, and as described later, causes the separation roller 54 to generate a conveying force for conveying the sheet S and a returning force for pushing the sheet S back in the direction opposite to the conveyance direction.

The paper feed device 13 of the embodiment drives the rotation shaft 160 of the motor 60 in the direction in which the separation roller 54 is rotated in the counterclockwise direction CCW when the sheet S is conveyed. Since the separation roller 54 is pressed against the paper feed roller 53, a frictional force is generated in the separation roller 54 due to contact with the paper feed roller 53. In the paper feed device 13, when the sheet S is not interposed between the paper feed roller 53 and the separation roller 54, the frictional force (load torque) generated on the separation roller 54 is larger than the limiting torque TLi for rotating the separation roller 54 in the counterclockwise direction CCW. When the sheet S is not interposed between the paper feed roller 53 and the separation roller 54, the separation roller 54 is in a state in which a load torque larger than the limiting torque TLi is applied. The motor 60 rotates in a direction (clockwise direction CW) opposite to a predetermined direction (counterclockwise direction CCW). The separation roller 54 is driven to follow the paper feed roller 53 and rotates in the clockwise direction CW.

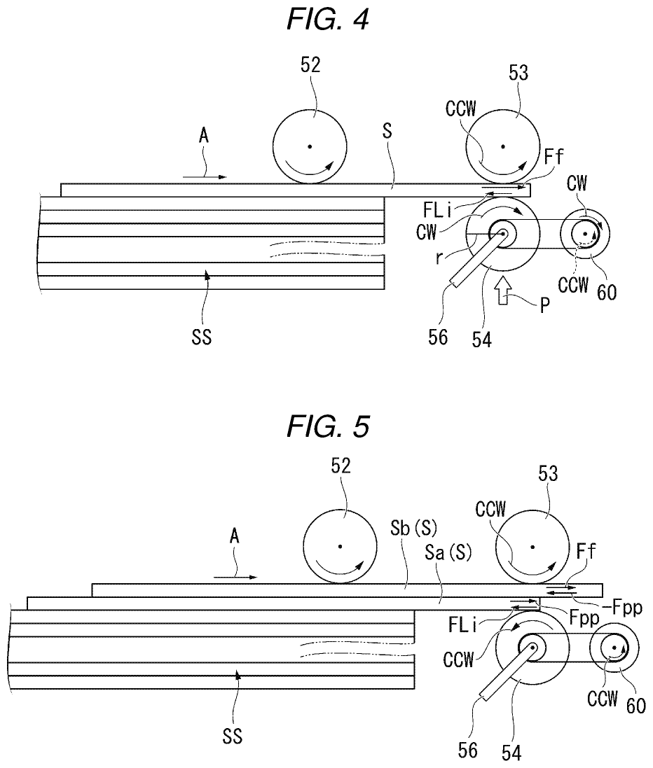

Next, a case where one sheet S is conveyed by the pickup roller 52 to the nip between the paper feed roller 53 and the separation roller 54 will be described. FIG. 4 is a diagram illustrating the operation of the paper feed roller 53 and the separation roller 54 when one sheet S is conveyed to the nip between the paper feed roller 53 and the separation roller 54.

In FIG. 4, the conveying force acting on the sheet S by the paper feed roller 53 is “Ff”, the returning force for pushing the sheet S back in a direction opposite to a conveyance direction A by the separation roller 54 is “FLi”, a coefficient of static friction between the paper feed roller 53 and the sheet S is “μf”, a pressing force by the roller pressing unit 56 is “P”, and a radius of the separation roller 54 is “r”. The conveying force Ff is prescribed by “μf×P”, and the returning force FLi is prescribed by “Tli/r”.

In the paper feed device 13 of the embodiment, when one sheet S is conveyed between the paper feed roller 53 and the separation roller 54, the conveying force Ff is set to exceed the returning force FLi (Ff>FLi). Specifically, the control unit 17 controls the supply current to the motor 60 to control the limiting torque TLi of the motor 60 so that the returning force FLi (TLi/r) becomes smaller than the conveying force Ff. Hereinafter, this condition is referred to as a first condition.

In the paper feed device 13 that satisfies the first condition, as illustrated in FIG. 4, the conveying force Ff acting on one sheet S becomes larger than the returning force FLi. When the first condition is satisfied, the separation roller 54 is in a state in which a load larger than the limiting torque TLi is applied thereto. Similarly, the motor 60 that drives the separation roller 54 is in a state in which the load larger than the limiting torque TLi is applied thereto.

The separation roller 54 and the motor 60 rotate in the clockwise direction CW which is the direction opposite to the counterclockwise direction CCW which is the original rotation direction. The separation roller 54, which rotates in the clockwise direction CW, abuts on the lower surface of the sheet S to generate the conveying force Ff that conveys the sheet S together with the paper feed roller 53. The sheet S is conveyed toward the conveyance path 24 by the paper feed roller 53 and the separation roller 54. The rotation shaft 160 of the motor 60 rotates in the clockwise direction (first direction) CW when generating the conveying force Ff.

As described above, in the paper feed device 13 of the embodiment, it is possible to cause the separation roller 54 to generate the conveying force Ff for conveying the sheet S by controlling the current to be supplied to the motor 60 of the roller drive unit 55 by the control unit 17.

Next, a case where two sheets S are conveyed between the paper feed roller 53 and the separation roller 54 will be described. FIG. 5 is a diagram illustrating an operation when two sheets S are conveyed between the paper feed roller 53 and the separation roller 54 in the paper feed device 13. In FIG. 5, of the two sheets S, the sheet S on the separation roller 54 side is referred to as a first sheet Sa and the sheet S on the paper feed roller 53 side is referred to as a second sheet Sb.

Here, the conveying force acting on the second sheet Sb by the frictional force generated between the two sheets S is “Fpp”, a resistance force due to friction between the sheets is “−Fpp”, a coefficient of static friction between the separation roller 54 and the sheet S is “μsep”, and a coefficient of static friction between the two sheets S is “μpp”. The Fpp is prescribed by “μpp×P”.

In the paper feed device 13 of the embodiment, when the two sheets S are conveyed between the paper feed roller 53 and the separation roller 54, the returning force FLi is set to exceed the conveying force Fpp and the conveying force Ff is set to exceed the resistance force −Fpp (FLi>Fpp, Ff>−Fpp). Specifically, the control unit 17 controls the supply current to the motor 60 to set the limiting torque TLi of the motor 60 so that the returning force FLi (TLi/r) becomes larger than the second conveying force Fpp. Hereinafter, this condition is referred to as a second condition.

In the paper feed device 13 that satisfies the second condition described above, as illustrated in FIG. 5, the returning force FLi acting on the second sheet Sb becomes larger than the second conveying force Fpp. The separation roller 54 is in a state in which a load smaller than the limiting torque TLi is applied thereto. Similarly, the motor 60 that drives the separation roller 54 is in a state in which a load larger than the limiting torque TLi is applied thereto.

The separation roller 54 and the motor 60 rotate in the counterclockwise direction CCW, which is the original rotation direction. The separation roller 54 that rotates in the counterclockwise direction CCW abuts on the lower surface of the second sheet Sb to generate the returning force FLi for pushing the second sheet Sb back in the direction opposite to the conveyance direction of the first sheet Sa. Since the second sheet Sb stays on the separation roller 54, the second sheet Sb is not conveyed along with the first sheet Sa. When the two sheets S (first sheet Sa and second sheet Sb) are conveyed between the paper feed roller 53 and the separation roller 54, the separation roller 54 plays a role of separating the second sheet Sb so that the second sheet Sb is not conveyed along with the first sheet Sa.

On the other hand, when the second condition described above is satisfied, the conveying force Ff acting on the first sheet Sa becomes larger than the resistance force −Fpp, and thus the first sheet Sa is conveyed to the conveyance path 24 by the paper feed roller 53. The rotation shaft 160 of the motor 60 rotates in the counterclockwise direction (second direction) CCW when generating the returning force FLi.

As described above, in the paper feed device 13 of the embodiment, it is possible to cause the separation roller 54 to generate the returning force FLi for pushing the sheet S back in the direction opposite to the conveyance direction by controlling the current to be supplied to the motor 60 of the roller drive unit 55 by the control unit 17. The paper feed device 13 can separate the two sheets S that are doubly fed and convey only the first sheet Sa to the conveyance path 24.

In the conventional paper feed device, a torque limiter and a motor are combined to cause the separation roller to generate the conveying force for conveying the sheet and the returning force for pushing the sheet back and to realize a sheet conveying function and a sheet separating function. On the other hand, in the paper feed device 13 in the image processing apparatus 1 of the embodiment, it is possible to cause the separation roller 54 to generate the conveying force Ff for conveying the sheet S and the returning force FLi for pushing back the sheet S and to realize the sheet conveying function and the sheet separating function, by controlling the current to be supplied to the motor 60. According to the paper feed device 13 of the embodiment, the double feeding of the sheets S can be suppressed only by controlling the supply current to the motor 60 without using the torque limiter, and thus reduction in size and cost of the apparatus configuration can be realized by the amount of the torque limiter omitted. Thus, it is possible to realize reduction in size and cost of the image processing apparatus 1 itself including the paper feed device 13.

In the paper feed device 13 of the embodiment, the type of the sheet S stored in the sheet feed cassette 51 maybe changed according to a user's printing request. When the type of the sheet S is changed, the frictional force that occurs between the sheet S, the paper feed roller 53, and the separation roller 54 and the inter-sheet frictional force between the two sheets S are changed.

In the conventional paper feed device, it is necessary to replace the torque limiter in order to change sheet conveyance and separation performance according to the type of sheet.

On the other hand, in the paper feed device 13 of the embodiment, the limiting torque TLi of the motor 60 can be adjusted to a value according to the type of the sheet S by controlling the current to be supplied to the motor 60 by the control unit 17. The control unit 17, for example, acquires information regarding the type of the sheet S from an input operation by the user on the control panel 16.

For example, when thick paper is selected as a type of the sheet S, in the paper feed device 13, the control unit 17 controls to reduce the amount of current to be supplied to the motor 60 of the roller drive unit 55. In the paper feed device 13, it is possible to improve conveyability of the sheet S by the paper feed roller 53 by reducing the limiting torque TLi of the motor 60. The thick paper means paper which is thicker than plain paper and has a basis weight of, for example, more than 90 g/m². The plain paper means paper having a basis weight of, for example, approximately 35 to 90 g/m².

For example, when paper having a large inter-sheet frictional force is selected as the type of the sheet S, in the paper feed device 13, the control unit 17 controls to increase the amount of current to be supplied to the motor 60 of the roller drive unit 55. In the paper feed device 13, the returning force FLi can be increased by the separation roller 54 by increasing the limiting torque TLi of the motor 60. Thus, even when the sheet S having the large inter-sheet frictional force is doubly fed, the sheet S can be easily separated by increasing the returning force FLi of the separation roller 54.

Hereinafter, a paper feed method using the image processing apparatus 1 of the embodiment will be described.

The paper feed method of the first embodiment includes a step of controlling a supply current to the roller drive unit 55 that drives the separation roller 54 so as to generate the conveying force for conveying the sheet S and the returning force for pushing the sheet S back in the direction opposite to the conveyance direction when the sheet S picked up from the sheet feed cassette 51 is conveyed using the paper feed roller 53 and the separation roller 54 pressed against the paper feed roller 53.

According to the paper feed method, the sheet conveying function and the sheet separating function by the separation roller 54 can be realized by controlling the supply current to the motor 60 without using the torque limiter. Accordingly, in the paper feed method, since the torque limiter is not used, the double feeding of the sheets S can be suppressed at low cost.

In the paper feed method, the sheet conveying performance and the sheet separating performance by the separation roller 54 can be changed by controlling the current to be supplied to the motor 60 according to the type of the sheet S to be conveyed. Thus, in the paper feed method, the double feeding of various types of sheets S can be suppressed.

### Second Embodiment

Hereinafter, a configuration of the image processing apparatus 1 of the second embodiment will be described. Detailed description of portions having the same configurations as those of the first embodiment will be omitted.

In the paper feed device 13 of the first embodiment, variations may occur in the sheet characteristics (for example, the magnitude of the inter-sheet frictional force) among the plurality of sheets S stored in the sheet feed cassette 51. If variations occur in such sheet characteristics, there is a concern that the double feeding of the sheets S occurs even when the supply current to the motor 60 is controlled to a predetermined value.

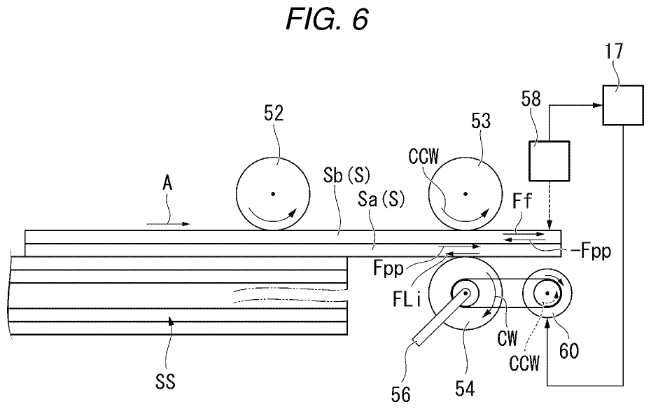

FIG. 6 is a side view illustrating a paper feed device 113 of the second embodiment.

The paper feed device 113 of the second embodiment includes the sheet feed cassette 51, the pickup roller 52, the paper feed roller 53, the separation roller 54, the roller drive unit 55, the roller pressing unit 56, and a double-feed detection unit 58.

The double-feed detection unit 58 detects the double feeding of the sheets S. The double-feed detection unit 58 is electrically connected to the control unit 17 and transmits the detection result to the control unit 17.

As the double-feed detection unit 58, for example, there is a detection unit that uses ultrasonic waves or a detection unit that uses sheet conveyance time. The detection unit that uses the ultrasonic wave includes an ultrasonic wave transmission sensor and an ultrasonic wave reception sensor which are disposed so as to pinch the sheet S from both sides. The detection unit that uses ultrasonic waves detects the double feeding from attenuation of the ultrasonic waves that occurs when the two sheets S are conveyed.

The detection unit that uses the sheet conveyance time includes a light receiving sensor that detects the presence or absence of the sheet S. The detection unit that uses the sheet conveyance time acquires the sheet conveyance time from the time until the sheet S conveyed by the paper feed roller 53 arrives. The detection unit that uses the sheet conveyance time compares the reference time calculated in advance from the sheet length with the sheet conveyance time and detects the double feeding of the sheets when the sheet conveyance time is longer than the reference time.

The double-feed detection unit 58 transmits the detection result to the control unit 17. The control unit 17 controls the supply current to the roller drive unit 55 based on the detection result of the double-feed detection unit 58. Specifically, when the control unit 17 determines, from the detection result of the double-feed detection unit 58, that the double feeding occurs, the control unit 17 controls so as to increase the amount of supply current to the roller drive unit 55. The control unit 17 increase the limiting torque TLi by the separation roller 54 by increasing the amount of supply current to the roller drive unit 55 (motor 60).

In the paper feed device 113 of the second embodiment, even if the double feeding of the sheets S occurs, the returning force FLi can be increased and the doubly fed sheets S can be separated by the separation roller 54, by increasing the limiting torque TLi of the motor 60. The paper feed device 113 of the second embodiment can further suppress the double feeding of the sheets S.

In the embodiments described above, although an example in which the image processing apparatus 1 performs image formation is described, the image processing apparatus 1 may be an image processing apparatus that performs image processing without performing image formation. For example, the image processing apparatus 1 may be an image processing apparatus that erases an image formed with a decolorable toner by heating, light irradiation, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus, comprising:
a sheet storage component;
a pickup roller configured to pick up a sheet from the sheet storage component;
a paper feed roller configured to convey the sheet picked up by the pickup roller;
a separation roller configured to be disposed to face the paper feed roller;
a roller pressing component configured to press the separation roller against the paper feed roller;
a roller drive component configured to drive the separation roller; and
a drive controller configured to control a current supplied to the roller drive component so as to generate a conveying force for conveying the sheet and a returning force for pushing the sheet back in a direction opposite to a conveyance direction on the separation roller.

2. The apparatus according to claim 1, wherein
the roller drive component comprises a motor having a torque controllable by the current.

3. The apparatus according to claim 2, wherein
the motor is a DC motor.

4. The apparatus according to claim 2, wherein
the roller drive component comprises a transmission component that transmits a driving force of the motor to the separation roller.

5. The apparatus according to claim 2, wherein
a rotation shaft of the motor rotates in a first direction when generating the conveying force, and rotates in a second direction opposite to the first direction when generating a returning force.

6. The apparatus according to claim 2, wherein
the rotation shaft of the motor rotates in the first direction when a load larger than a prescribed torque is applied, and rotates in the second direction when a load smaller than the prescribed torque is applied.

7. The apparatus according to claim 4, wherein
the transmission component comprises a first pulley provided on the motor, a second pulley provided on the separation roller, and a belt stretched between the first pulley and the second pulley.

8. The apparatus according to claim 1, wherein
the drive controller is configured to control an amount of the current according to a type of the sheet.

9. The apparatus according to claim 1, further comprising:
a double-feed detection component configured to detect the double feeding of the sheets, wherein
the drive controller is configured to control the current supplied to the roller drive component based on a detection result of the double-feed detection component.

10. The apparatus according to claim 1, wherein
the pickup roller is configured to pick up a single sheet from the sheet storage component; and
the paper feed roller is configured to convey the single sheet picked up by the pickup roller, with the proviso that two or more sheets are not conveyed at one time by the paper feed roller.

11. A paper feed method, comprising:
controlling a supply current to a roller drive component that drives a separation roller so as to generate a conveying force for conveying a sheet and a returning force for pushing the sheet back in a direction opposite to a conveyance direction, when the sheet picked up from a sheet storage component is conveyed using a paper feed roller and a separation roller pressed against the paper feed roller.

12. The method according to claim 11, further comprising:
controlling the supply current to the roller drive component to control a torque of a motor.

13. The method according to claim 12, wherein
the motor is a DC motor.

14. The method according to claim 12, further comprising:
transmitting a driving force of the motor to the separation roller.

15. The method according to claim 12, further comprising:
rotating a rotation shaft of the motor in a first direction when generating the conveying force, and rotating in a second direction opposite to the first direction when generating a returning force.

16. The method according to claim 12, further comprising:
rotating a rotation shaft of the motor in a first direction when a load larger than a prescribed torque is applied, and rotating in a second direction when a load smaller than the prescribed torque is applied.

17. The method according to claim 14, wherein
transmitting is carried out by a first pulley provided on the motor, a second pulley provided on the separation roller, and a belt stretched between the first pulley and the second pulley.

18. The method according to claim 11, further comprising:
controlling an amount of the current according to a type of the sheet.

19. The method according to claim 11, further comprising:
detecting a double feeding of the sheets; and
controlling the current supplied to the roller drive component based on a detection result.

20. The method according to claim 11, further comprising:
picking up a single sheet from the sheet storage component; and
conveying the single sheet picked up, with the proviso that two or more sheets are not conveyed at one time by the paper feed roller.
